(19) United States
(12) Patent Application Publication
(10) Pub. No.: US 2016/0356654 A1
(43) Pub. Date: Dec. 8, 2016

(54) A DEVICE FOR FASTENING A SENSOR ON A PART

(71) Applicant: SAFRAN HELICOPTER ENGINES, Bordes (FR)

(72) Inventors: Olivier Pierre DESCUBES, Nay (FR); Thomas DROUIN, Sedzere (FR); Emilie DURRBACH, Pau (FR); José-Alexandre PINA-ANDRADE, Mourenx (FR)

(73) Assignee: SAFRAN HELICOPTER ENGINES, Bordes (FR)

(21) Appl. No.: 15/117,679

(22) PCT Filed: Feb. 6, 2015
(86) PCT No.: PCT/FR2015/050287

§ 371 Date: Aug. 9, 2016

(30) Foreign Application Priority Data
Feb. 11, 2014 (FR) 1451033

(51) Int. Cl. G01K 1/14; G01K 7/02

(52) U.S. Cl. CPC G01K 1/14; G01K 7/02

(57) ABSTRACT

The invention relates to a fastener device (100) for fastening at least one sensor, in particular a thermocouple, to a part, the device comprising a first fastener portion (10) having fastener means (14) for fastening to the part and a second fastener portion provided with an orifice for receiving the sensor (90). According to the invention, the device further comprises an elastically deformable portion (20) connecting together the first and second fastener portions, and the elastically deformable portion (20) is configured in such a manner as to pass from a stable position to an unstable position when the first fastener portion (10) is fastened to a part, thereby pressing the second fastener portion against the part.

### TECHNICAL FIELD

The present invention relates to a device fastening at least one sensor on a part.

The fastener device of the invention is particularly adapted for fastening a thermocouple, in particular to a turbine casing in a turbine engine.

### BACKGROUND OF THE INVENTION

In certain circumstances, it is necessary to place a measurement sensor on a part in order to measure local properties of the part or in the immediate vicinity of the part, in particular while the device including the part is in operation. For example, the sensor may be a thermocouple that measures the temperature of a portion of the part on which it is placed.

In order to take good measurements, it is necessary to hold the sensor in a desired position relative to the portion of the part.

At present, a fastener device is known that comprises a plate that is fastened to the part by a single fastener screw and that is provided, in the vicinity of the screw, with a reception orifice for the sensor, the sensor generally being welded to the plate. With such a fastener device, the tension applied to the screw by the tightening torque may lead to the plate lifting, allowing air to leak between the part and the plate, and thus locally modifying the temperature on the part and in its vicinity.

Another known fastener device comprises a plate fastened to the part by two fastener screws, the sensor itself being fastened to the plate between the two screws. That fastener device, although more reliable, is nevertheless greater in size than the previously-described device, and is thus difficult to fit on existing structures, either because there is not enough room to enable it to be integrated, or because the part itself needs to be modified beforehand in order to receive the device.

### OBJECT AND SUMMARY OF THE INVENTION

The object of the present invention is to provide a device that enables a sensor to be fastened on a part in reliable manner, while overcoming the above-mentioned drawbacks.

This object is achieved with a fastener device for fastening at least one sensor, in particular a thermocouple, to a part, the device comprising a first fastener portion having fastener means for fastening to the part and a second fastener portion provided with an orifice for receiving the sensor, the device being characterized in that it further comprises an elastically deformable portion connecting together the first and second fastener portions, the elastically deformable portion being configured in such a manner as to pass from a stable position to an unstable position when the first fastener portion is fastened to a part, thereby pressing the second fastener portion against the part.

The elastically deformable portion of the device of the invention is adapted to pass from a stable position to an unstable position by bending. It can be understood that the relative positioning of the first and second fastener portions differs depending on whether the elastically deformable portion is in its stable position or its unstable position.

When it is in its unstable position, the elastically deformable portion tends continuously to return towards its stable position, i.e. to return the first and second portions to their relative position at rest. Assuming the first fastener portion is stationary—because it is fastened to the part—the force tending to return the elastically deformable portion to its stable position is applied to the second fastener portion that remains free. Since the second fastener portion is in abutment against the part, this force is maintained in the form of relatively uniform continuous contact pressure around the sensor and acting between the second fastener portion and the part.

By deformation of the elastically deformable portion during assembly on the part, the fastener device is thus subjected to pre-loading that prevents the second fastener portion lifting off the part. It is thus possible to take measurements with the sensor, while avoiding any leaks at the interface between the sensor and the surface on which it is fastened.

Also, because of the above-specified provisions, the device of the invention can be used with a single fastener screw, thus making it possible to make it more compact and easier to integrate in existing structures.

Finally, since the fastener device of the invention presents a degree of springiness, it can be used on surfaces that present non-negligible amounts of local deformation, e.g. on turbine engine casing surfaces that present large amounts of deformation in use.

In an example, the elastically deformable portion comprises at least one spring blade.

In an example, the elastically deformable portion includes a return extending away from a portion of the spring blade that is spaced apart from the first fastener portion (e.g. and in non-limiting manner, its end remote from the first fastener portion), towards said first fastener portion, and the second fastener portion is secured to the return.

In an example, the elastically deformable portion comprises two spring blades that are spaced apart from each other.

Under such circumstances, the return advantageously extends between the two spring blades.

In an example, the second fastener portion has a substantially plane secondary bearing surface that is adapted to come into contact with the part.

Advantageously, the secondary bearing surface surrounds the sensor once it has been mounted in the reception orifice, whereby a continuous contact pressure zone can be obtained around the sensor after it has been mounted on the part.

In an example, the first fastener portion also has a substantially plane primary bearing surface that is adapted to come into contact with the part.

In an advantageous provision, the primary and secondary bearing surfaces are substantially parallel when the elastically deformable portion is in its stable position.

In an example, when the elastically deformable portion is in its stable position, the secondary bearing surface is spaced apart from the primary bearing surface in a direction substantially orthogonal to the primary bearing surface, going away from said first fastener portion. It is thus ensured that the elastically deformable portion deforms when the device is fastened on a substantially plane support surface of a part.

In an example, the second fastener portion comprises a reception ring for receiving the sensor and fastened to the elastically deformable portion, and the secondary bearing surface is a surface of said ring.

By way of example the reception ring is a sealing ring for providing sealing around the sensor when the second fastener portion is pressed against the part.

In an example, the first fastener portion and the elastically deformable portion form an integral unit, in particular obtained by being cut out from sheet metal.

The invention also provides an assembly comprising a fastener device as defined above together with a sensor, in particular a thermocouple, secured to the second fastener portion.

### BRIEF DESCRIPTION OF THE DRAWINGS

The invention can be well understood and its advantages appear better on reading the following detailed description of an embodiment shown as a non-limiting example. The description refers to the accompanying drawings, in which:

FIG. 1 is a perspective view from above of a fastener device in a first embodiment of the invention, in its initial state;

FIG. 2 is a perspective view from above of the FIG. 1 device in section on its plane of symmetry P;

FIG. 3 is a perspective view from below of the FIG. 1 device;

FIGS. 4 and 5 show steps of fastening a sensor on a part using a device as shown in FIGS. 1 to 3, the device being shown in section on II-II of FIG. 1;

FIG. 6 is a perspective view from above of a fastener device in a second embodiment of the invention, in its initial state;

FIG. 7 is a perspective view from beneath of the FIG. 6 device in section on its plane of symmetry P; and

FIGS. 8 and 9 show steps of fastening a sensor on a part using a device as shown in FIGS. 6 and 7, the device being shown in section on II-II of FIG. 1.

### DETAILED DESCRIPTION OF AN EMBODIMENT

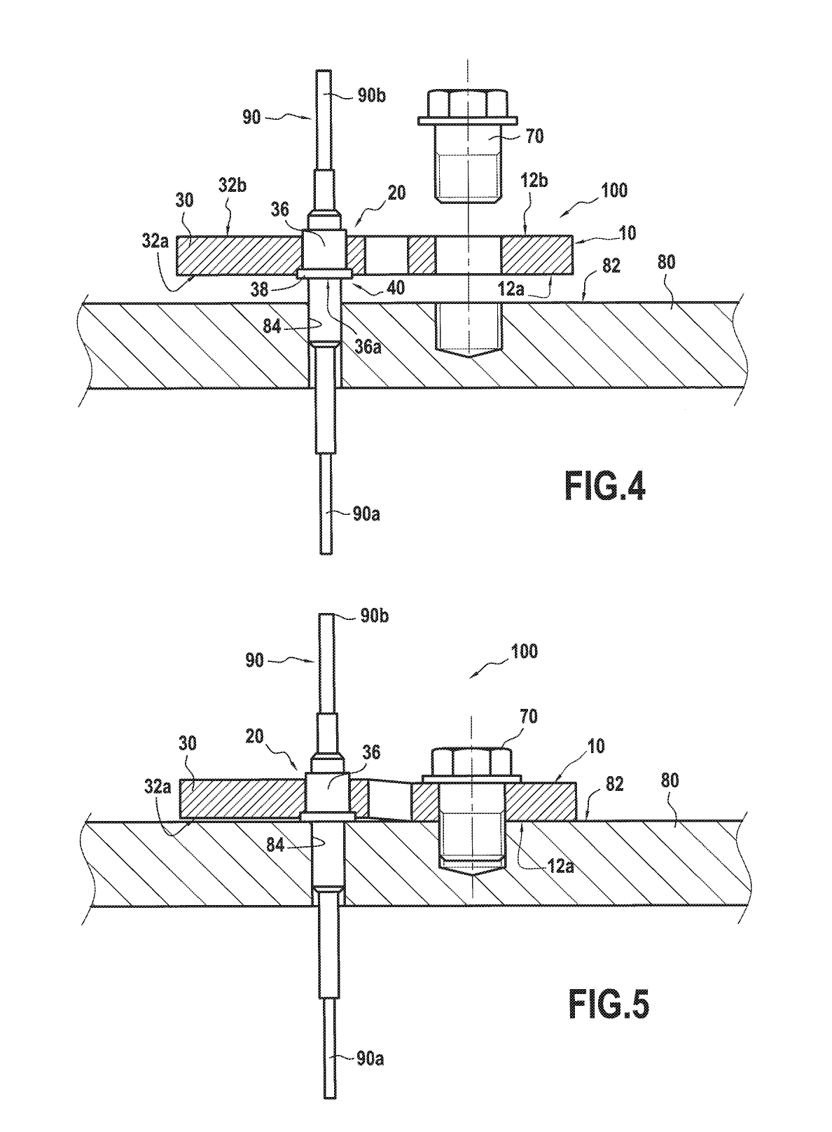

FIGS. 4 and 5 are diagrams showing, in section view, a portion 80 of a part on which it is desired to fasten a sensor 90. In the example shown, this portion 80 is a plate of thickness e.

For example, the part is a turbine casing, and the property that it is desired to measure using the sensor 90 is the temperature inside said turbine. The sensor used is thus a thermocouple with a measurement end 90a, where the measurement is taken, that needs to be positioned at the location desired for this measurement, in other words inside the turbine.

Advantageously, the thermocouple 90 is fastened so as to pass through the part 80 via an orifice 84 formed in said part 80, its measurement end 90a projecting into the inside of the part 80, and its opposite end 90b, generally connected to means for reading the result (not shown), being arranged on the outside of the part 80.

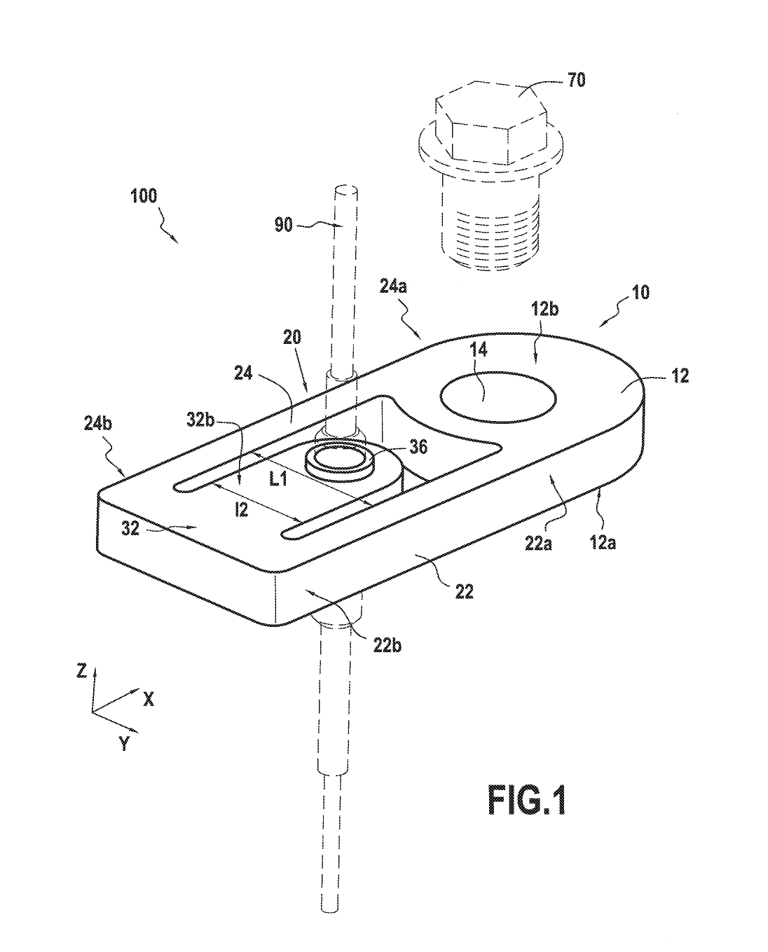

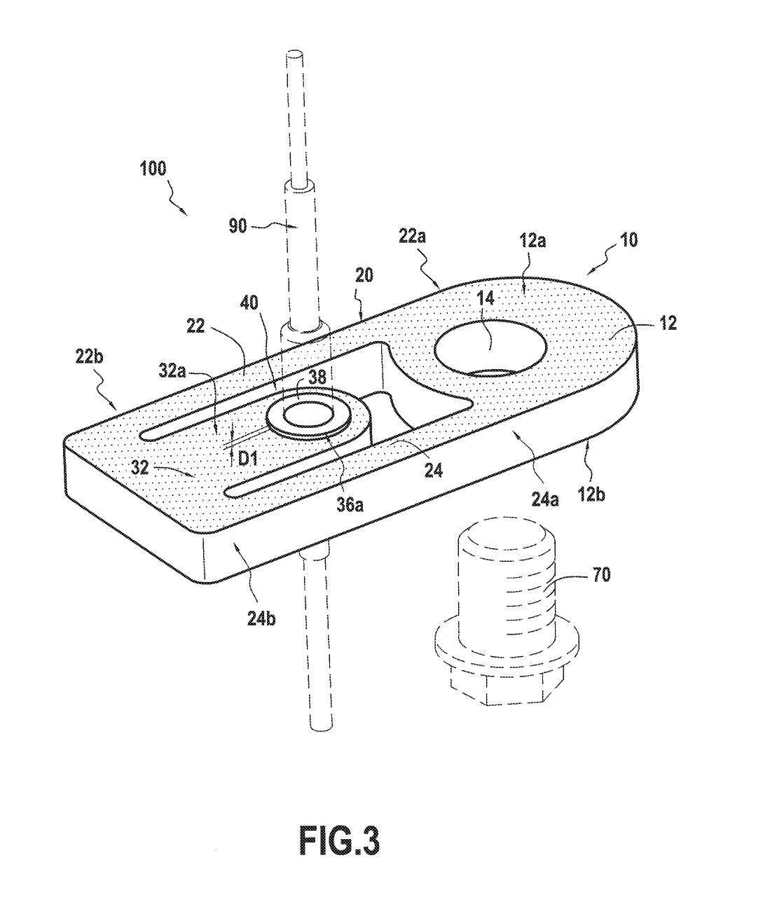

FIGS. 1 to 3 show in greater detail a device 100 of the invention suitable for being used for fastening a sensor 90, as described above, on a part 80.

In this example, the fastener device 100 comprises a first fastener portion 10 provided with means for fastening the device to the part 80, a second fastener portion 40 provided with an orifice for receiving the sensor 90, and an elastically deformable portion 20 connecting together the first and second fastener portions.

In FIGS. 1 to 3, the elastically deformable portion 20 is in a stable position corresponding to a state in which no external force is being applied thereto.

In an example, the first fastener portion 10 is in the form of a plate 12 defined by two main surfaces, a bottom surface 12a and a top surface 12b, which surfaces extend substantially orthogonally to a transverse direction Z.

The bottom surface 12a of the first fastener portion 10 in this example forms a primary bearing surface 12a for bearing against the part when the device is mounted.

In this example, the fastener means include a fastener orifice 14 passing right through the first portion and extending in a direction that is orthogonal to the two main surfaces 12a, 12b. As is described in greater detail below, the fastener orifice 14 is for receiving a fastener screw 70 enabling the device to be anchored to the part. Nevertheless, the example shown is not limiting, and in variants, the fastener means may comprise a plurality of fastener holes and/or other means enabling the device to be fastened to the part.

As described below, the device 100 of the invention nevertheless presents the advantage of providing fastening that is reliable even when it is fastened at a single point (in particular by a single fastener screw).

In order to facilitate understanding the figures, the primary bearing surface 12a and all of the surfaces of the device 100 that are to face the part are shown lightly shaded.

It should be observed that the fastener device 100 presents symmetry about a plane P shown in FIG. 1.

In this example, the fastener orifice 14 is thus in alignment with the plane of symmetry P.

Below, and unless specified to the contrary, a lateral direction Y of the device is defined as a direction orthogonal to the transverse direction Z and to the plane of symmetry P, and a longitudinal direction X is defined as being a direction orthogonal to the lateral and transverse directions Y and Z.

In this example, the elastically deformable portion 20 comprises two flexible branches 22 and 24 forming spring blades that extend from the first portion 10.

More particularly, each spring blade 22, 24 is connected to a respective lateral end of the first portion 10. In a plane orthogonal to the transverse direction Z, the two spring blades 22, 24 extend from the first fastener portion 10 in the longitudinal direction X and they form the branches of a U-shape, with the first portion constituting the base of the U-shape.

In this example, the two blades 22 and 24 are substantially parallel, being spaced apart from each other transversely by an empty space 26 of width L1.

It can be understood that the spring blades 22, 24 are suitable for flexing so that their ends 22b, 24b remote from the first portion move relative to said first portion 10, in particular by tilting relative to a plane orthogonal to the transverse direction Z (see FIG. 5), thus bringing the elastically deformable portion 20 into an unstable position.

In this example, the elastically deformable portion 20 also has a return 32, of width L2 that is strictly less than L1 and that extends in this example from the respective end 22b, 24b of each spring blade 22, 24 remote from the first fastener portion 10 towards said first fastener portion 10.

The return 32 thus extends in the empty space 26 that is defined laterally by the spring blades 22, 24.

In this example, when the elastically deformable portion 20 is in its stable position as shown in FIGS. 1 to 3, the return 32 is defined by two plane main surfaces, a bottom surface 32a and a top surface 32b, which surfaces extend orthogonally to the transverse direction Z. From FIGS. 4 and 5, it can be understood that the bottom surface 32a is to be placed facing the surface 82 of the part 80, after assembly.

In this example, the first portion 10, the spring blades 22, 24, and the return 32 are made as a single piece. These elements constitute an integral unit that can be obtained in particular by being cut from sheet metal.

The respective top surfaces 12b, 32b of the first portion 12 and of the return 32 are substantially coplanar in this example, as are their bottom surfaces 12b, 32b.

As shown in FIGS. 1 to 3, the return 32 includes an opening 34, into which there is inserted a reception ring 36 for receiving the sensor.

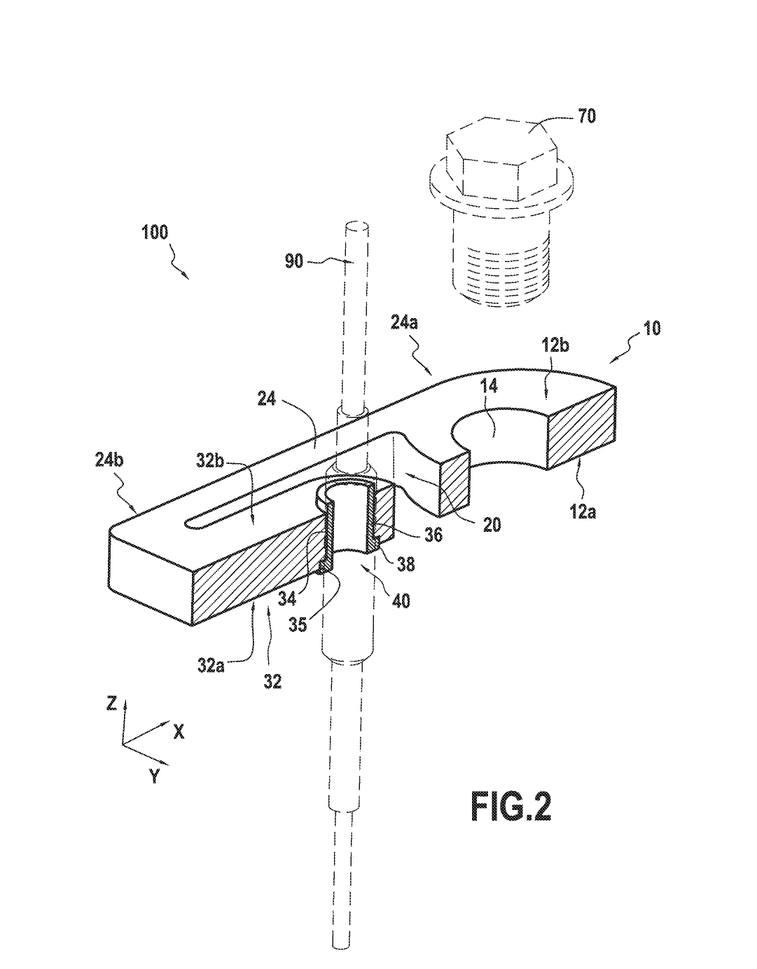

As shown in FIGS. 2, 3, and 4 in particular, the reception ring 36 projects from the bottom surface 32a of the return 32, over a distance D1.

The reception ring 36 thus has a surface 36a (its bottom surface), that is offset relative to the primary bearing surface 12a in the stable position of the elastically deformable portion 20 as shown in FIGS. 1 to 3 and that is to be pressed against the surface of the part during assembly.

The primary and secondary bearing surfaces 12a, 36a are defined in two parallel planes that do not coincide, being offset in the transverse direction Z.

In this example, the opening 34 in the return and the ring 36 form a second fastener portion 40.

In this example, the reception ring 36 forms a sealing element for providing sealing around the sensor after assembly.

In this example, the reception ring 36 is in the form of a cylindrical sleeve of outside profile that is complementary in shape to the inside wall of the opening 34 and of inside profile that is configured to receive the sensor 90. By way of example, the sensor 90 may be fastened to the reception ring 36 by welding or as a shrink fit.

At one of its ends, the reception ring 36 has an outer collar 38 that is engaged in an annular recess 35 of corresponding shape made around the opening 34 in the bottom surface of the return 32.

In this example, in order to ensure that it projects as mentioned above, the height of the outer collar 38 is slightly greater than the depth of the annular recess 34, which height and depth are measured in the transverse direction Z.

An assembly comprising a device 100 as described above and a measurement sensor 90 previously fastened to the device 100 is fastened in the manner described below with reference to FIGS. 4 and 5.

The part 80 onto which the sensor is to be fastened is shown in FIG. 4. In this example, its support surface 82 that is to receive the device 100 is plane.

When the fastener device 100 is moved towards the surface 82 of the part 80 (with its transverse direction Z extending substantially orthogonally to said surface 82, for example), the secondary bearing surface 36a comes into abutment against the support surface 82, before the first portion 10 comes into contact with said surface 82.

When the first portion 10 is moved even closer to the support surface 82, with the second portion 40 being held in abutment against this surface, the elastically deformable portion 20 deforms progressively and leaves its stable position.

The first fastener portion 10 is then fastened to the part 80, e.g. by means of a screw 70 engaged in the fastener hole 14 and screwed into the surface 82.

In this position, the return force from the elastically deformable portion 20, which tends to return it towards a stable position, becomes applied to the second fastener portion 40. This second portion 40 is then continuously urged elastically towards the part 80, maintaining relatively uniform contact pressure around the thermocouple between the secondary bearing surface 36a and the support surface 82 of the part 80, and compatible with providing sealing by contact.

Because of the relatively uniform contact pressure provided around the sensor, the sealing between the ring 36 and the part 80 may take place merely by contact, and the constraints on surface roughness and on planeness for the remainder of the fastener device, and in particular for the return 32 and for the spring blades 22, 24, are reduced.

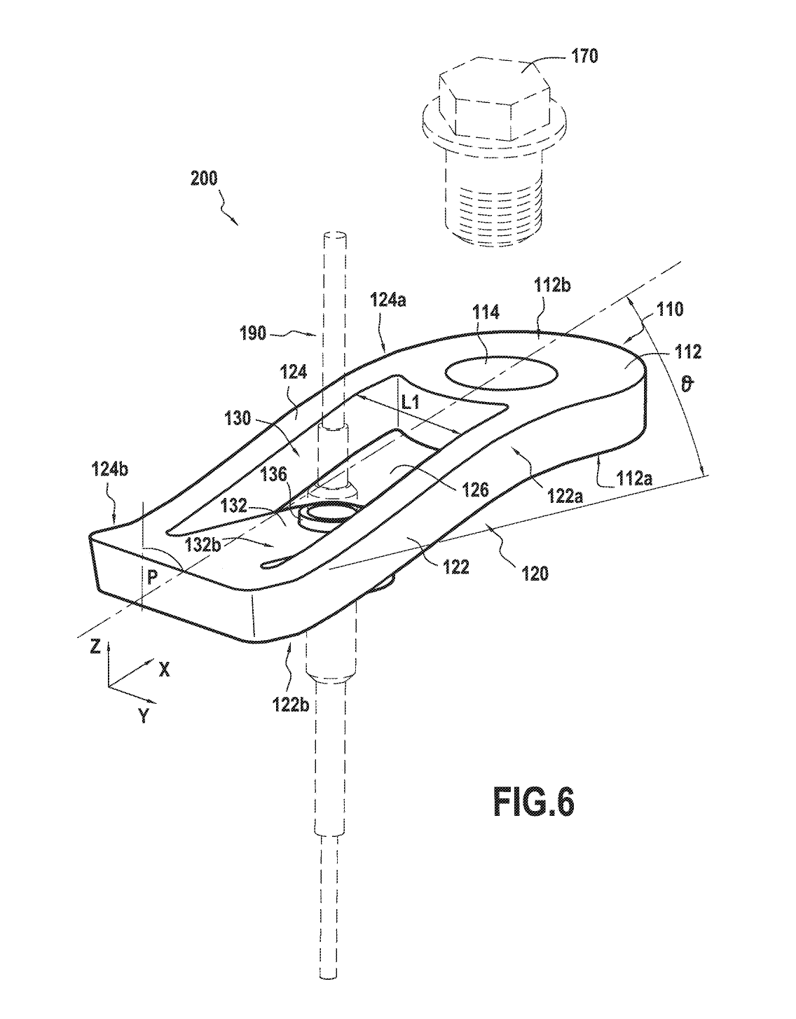

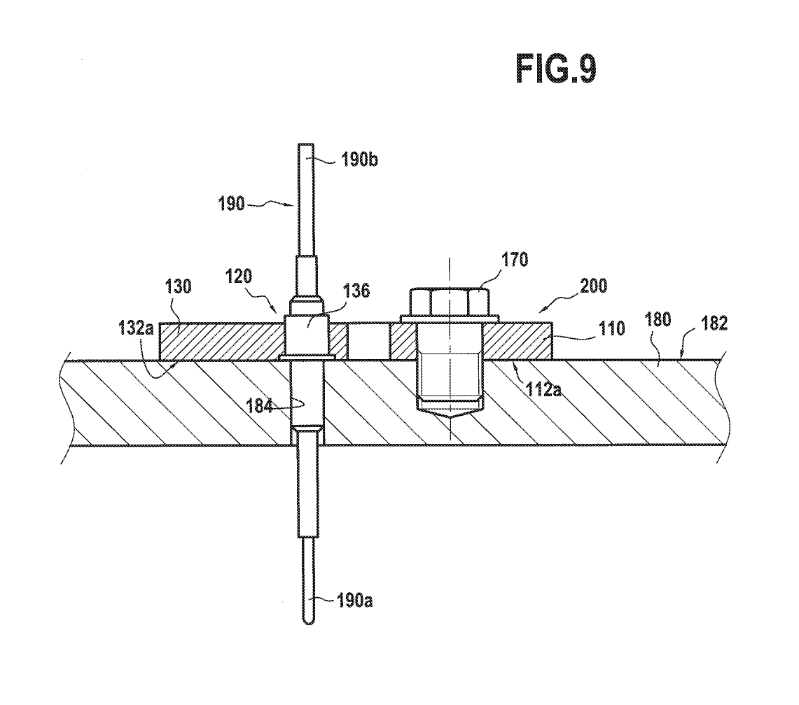

A fastener device 200 in a second embodiment of the invention is described below with reference to FIGS. 6 to 9.

In these figures, elements that are similar or identical to those described with reference to the first embodiment are designated by the same numerical references as in FIGS. 1 to 5, plus 100.

In this example, in the stable position of the elastically deformable portion 120, the two spring blades 122, 124 are inclined relative to a plane orthogonal to the transverse direction Z by an angle of inclination el that may have any other appropriate value.

Under such circumstances, the preloading to which the device 200 is subjected once it has been assembled is due at least in part to the initial inclination of the spring blades 122, 124 and to the resulting offset between the return 132 and the first portion 110.

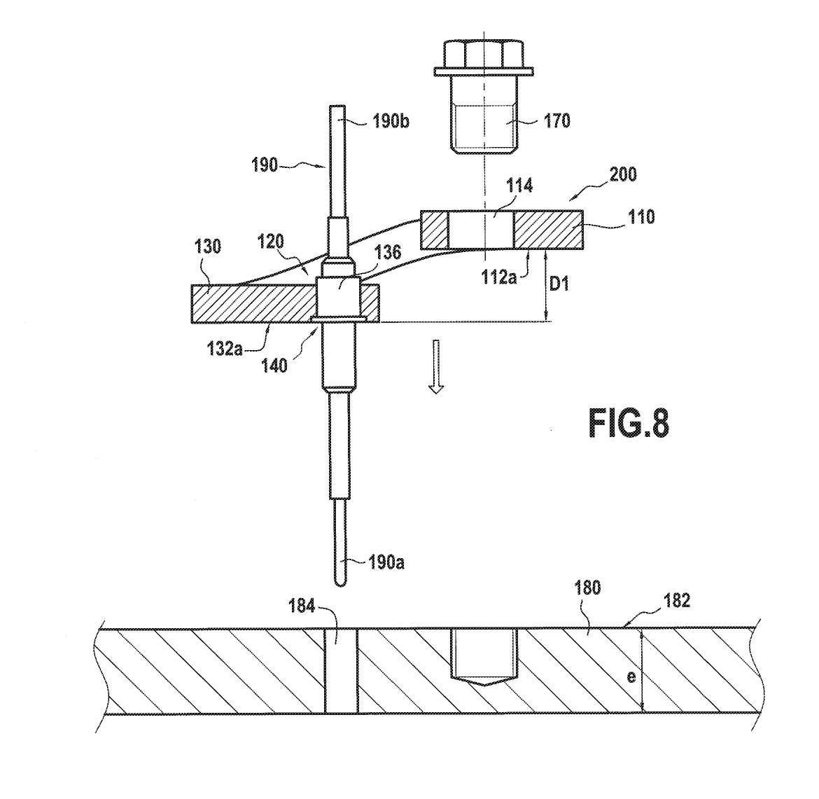

As shown in FIG. 8, when the fastener device 200 is moved towards the surface 182 of the part 180, the return 132 and the reception ring 140 are the first to come into abutment against the support surface 82.

When the first portion 110 is brought towards the support surface 182, the spring blades 122, 124 deform progressively.

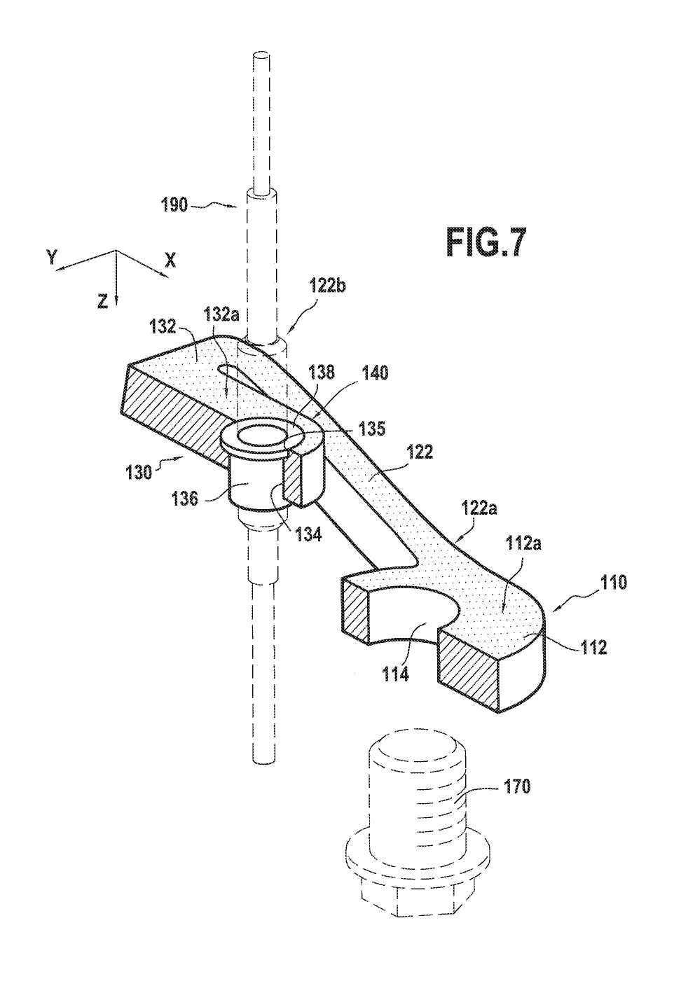

With such an arrangement, and as shown in FIGS. 7, 8, and 9, there is no longer any need for the reception ring 136 of the sensor to project from the bottom surface of the return 132.

It is even possible to imagine that the sensor is mounted directly in the opening 134 of the return 132, the return 132 then forming the second fastener portion 140, its bottom surface 132a constituting the secondary bearing surface of the device.

Nevertheless, the above-described examples are not limiting.

In other example uses, the surface of the part may present one or more setbacks, in particular. A first support surface portion that is to receive the first fastener portion and a second support surface portion that is to receive the second fastener portion may occupy different planes, planes that might slope relative to each other or that might be parallel. The fastener device is then arranged accordingly but it remains such that, when the first fastener portion is fastened to a first support surface portion, the elastically deformable portion passes from a stable position to an unstable position in which the second fastener portion is pressed against the second support surface portion.

1. A fastener device for fastening at least one sensor, in particular a thermocouple, to a part, the device comprising a first fastener portion having fastener means for fastening to the part and a second fastener portion provided with an orifice for receiving the sensor, the device further comprising an elastically deformable portion connecting together the first and second fastener portions, the elastically deformable portion comprising at least one spring blade and being configured in such a manner as to pass from a stable position to an unstable position when the first fastener portion is fastened to a part, thereby pressing the second fastener portion against the part.

2. A fastener device according to claim 1, wherein the elastically deformable portion includes a return extending away from a portion of the spring blade that is spaced apart from the first fastener portion, towards said first fastener portion, and the second fastener portion is secured to said return.

3. A fastener device according to claim 1, wherein the elastically deformable portion comprises two spring blades that are spaced apart from each other.

4. A fastener device according to claim 2, wherein the return extends between the two spring blades.

5. A fastener device according to claim 1, wherein the second fastener portion has a substantially plane secondary bearing surface that is adapted to come into contact with the part.

6. A fastener device according to claim 5, wherein the second fastener portion comprises a reception ring for receiving the sensor and fastened to the elastically deformable portion, and the secondary bearing surface is a surface of said ring.

7. A fastener device according to claim 5, wherein the first fastener portion has a substantially plane primary bearing surface adapted to come into contact with the part, and the primary and secondary bearing surfaces are substantially parallel when the elastically deformable portion is in its stable position.

8. A fastener device according to claim 7, wherein when the elastically deformable portion is in its stable position, the secondary bearing surface is spaced apart from the primary bearing surface in a direction substantially orthogonal to the primary bearing surface, going away from said first fastener portion.

9. An assembly comprising a fastener device according to claim 1, and a sensor secured to the second fastener portion.
